(19) United States
(12) Patent Application Publication
(10) Pub. No.: US 2022/0165451 A1
(43) Pub. Date: May 26, 2022

(54) ELECTRICAL CONDUCTING WIRE, INSULATED WIRE, COIL, AND ELECTRICAL OR ELECTRONIC EQUIPMENT

(71) Applicant: Essex Furukawa Magnet Wire Japan Co., Ltd., Tokyo (JP)

(72) Inventors: Keiichi TOMIZAWA, Tokyo (JP); Akira TACHIBANA, Tokyo (JP); Daisuke MUTO, Tokyo (JP)

(73) Assignee: Essex Furukawa Magnet Wire Japan Co., Ltd., Tokyo (JP)

(21) Appl. No.: 17/669,175

(22) Filed: Feb. 10, 2022

Related U.S. Application Data
(63) Continuation of application No. PCT/JP2020/028422, filed on Jul. 22, 2020.

(30) Foreign Application Priority Data
Sep. 13, 2019 (JP) 2019-167401

(51) Int. Cl. H01B 7/02; H01B 1/02; H01B 3/30; H01B 3/36; H01F 5/06

(52) U.S. Cl. CPC H01B 7/02; H01B 1/02; H01F 5/06; H01B 3/36; H01B 3/306

(57) ABSTRACT

Provided is an electrical conducting wire in which eddy current loss is effectively suppressed, mechanical strength is excellent, and electrical conductivity is also excellent while aluminum strands that are not coated with insulating resin are used as strands constituting a split conductor.

An electrical conducting wire, including:
a split conductor composed of multiple aluminum strands arranged in parallel to each other or multiple aluminum strands twisted into a helix, wherein each of the strands contains 0.01 to 0.4 mass % of Fe, 0.3 to 0.5 mass % of Cu, 0.04 to 0.3 mass % of Mg, 0.02 to 0.3 mass % of Si, and 0.001 to 0.01 mass % of Ti and V in total, with the balance being Al and inevitable impurities; and
wherein each of the strands is not coated with an insulating resin.

### CROSS-REFERENCE TO RELATED APPLICATIONS

This application is a Continuation of PCT International Application No. PCT/JP2020/028422 filed on Jul. 22, 2020, which claims priority under 35 U.S.C. § 119 (a) to Japanese Patent Application No. 2019-167401 filed in Japan on Sep. 13, 2019. Each of the above applications is hereby expressly incorporated by reference, in its entirely, into the present application.

### FIELD OF THE INVENTION

The present invention relates to an electrical conducting wire, an insulated wire, a coil, and electrical or electronic equipment.

### BACKGROUND OF THE INVENTION

In an inverter-related device (such as coils for electrical or electronic equipment, including high-speed switching devices, inverter motors, transformers, and the like), an insulated wire in which an insulating film containing an insulating resin is provided on the outer periphery of a conductor is used as a magnet wire.

It is known that eddy current loss can be reduced by using a split conductor obtained by splitting the conductor of an insulated wire into a plurality of strands. However, when the strands constituting the split conductor are in continuity with each other, no eddy current loss reducing effect is obtained. So the outer peripheries of the split conductor strands are individually coated with insulating resin. Namely, multiple strands individually coated with an insulating layer are arranged substantially in parallel to each other, or multiple strands each coated with an insulating layer are twisted into a helix to form a stranded wire, and further, the entire outer periphery of the split conductor is integrally covered with insulation to produce an insulated wire including the split conductor.

There is also known a technique in which multiple metal conductors individually surface-coated with oxide film are laminated to form a split conductor (see, for example, Patent Literature 1). The oxide film can be spontaneously formed on the metal surface by exposure to air, and this oxide film functions as an insulating layer.

### CITATION LIST

### Patent Literatures

Patent Literature 1: JP-A-2009-245666 (“JP-A” means an unexamined published Japanese patent application)

### SUMMARY OF THE INVENTION

### Technical Problem

Recent years have seen increasing calls for weight reduction of electrical or electronic equipment such as motors. Therefore, insulated wirers using aluminum, which is lighter than copper, as a conductor have been developed. As a result of repeated studies, the present inventors have found that when aluminum is used for the strands of a split conductor, the oxide film on the aluminum is relatively strong, and eddy current loss can be minimized to some extent even when no coating treatment using an insulating resin is applied to the strands. However, aluminum is weak in mechanical strength, and when used in a split conductor whose individual strands are themselves thin, the aluminum wire is likely to break (incur wire breakage) at the time of processing or assembly. In addition, given the recent spread of hybrid cars and electric vehicles, an insulated wire suitable for application to high-voltage motors is desirable, but the insulating property of the oxide film formed on the surface of the aluminum strands is not necessarily sufficient for this purpose.

The present invention provides an insulated wire that is capable of effectively reducing eddy current loss, is excellent in mechanical strength, and is also excellent in electrical conductivity, even though aluminum strands not coated with insulating resin are used as strands constituting its split conductor. The present invention also provides an electrical conducting wire suitable for a split conductor constituting the insulated wire.

### Solution to Problem

As a result of intensive studies against the backdrop of the above problems, the present inventors have found that by applying an aluminum strand having a specific composition and not coated with an insulating resin as a strand constituting a split conductor, it is possible to impart an electrical conductivity equivalent to that in a case of using pure aluminum as a strand to an insulated wire to be obtained, to further increase mechanical strength, to thicken an oxide film generated on the surface of the strand by spontaneous oxidation, and to effectively suppress eddy current loss. The present invention has been completed based on these findings.

The above problems of the present invention are solved by the following means.

[1]

An electrical conducting wire, including:
a split conductor composed of multiple aluminum strands arranged in parallel to each other or multiple aluminum strands twisted into a helix,
wherein each of the strands contains 0.01 to 0.4 mass % of Fe, 0.3 to 0.5 mass % of Cu, 0.04 to 0.3 mass % of Mg, 0.02 to 0.3 mass % of Si, and 0.001 to 0.01 mass % of Ti and V in total, with the balance being Al and inevitable impurities; and
wherein each of the strands is not coated with an insulating resin.
   [2]

The electrical conducting wire described in the item [1], wherein a tensile strength of each of the strands is 100 MPa or more.

[3]

The electrical conducting wire described in the item [1], wherein an electrical conductivity of each of the strands is 58% IACS or more.

[4]

An insulated wire, including: the electrical conducting wire described in the item [1]; and an insulating film coating an outer periphery of the electrical conducting wire.

[5]

The insulated wire described in the item [4], wherein the insulating film is an enamel layer.

[6]

The insulated wire described in the item [4], wherein the insulating film contains polyimide.

[7]

The insulated wire described in the item [4], wherein the insulating film contains polyetheretherketone.

[8]

The insulated wire described in the item [4], including an adhesion layer between the insulating film and the electrical conducting wire, wherein the adhesion layer contains polyetherimide.

[9]

A coil, including the insulated wire described in item [4].

[10]

An electrical or electronic equipment, including the coil described in the item [9].

In the description of the present invention, any numerical expressions in a style of “. . . to . . . ” will be used to indicate a range including the lower and upper limits represented by the numerals given before and after “to”, respectively.

### Advantageous Effects of Invention

The insulated wire of the present invention can effectively suppress eddy current loss even though an aluminum strands that are not coated with insulating resin are used as strands constituting its split conductor, and is excellent in mechanical strength and electrical conductivity. In addition, the electrical conducting wire of the present invention is suitable for a split conductor constituting the insulated wire of the present invention.

### BRIEF DESCRIPTION OF DRAWINGS

FIG. 1 is a schematic sectional view showing one embodiment of the insulated wire of the present invention.

FIG. 2 is a schematic perspective view showing a preferable embodiment of a stator to be used in electrical or electronic equipment of the present invention.

FIG. 3 is a schematic exploded perspective view showing a preferable embodiment of the stator to be used in the electrical or electronic equipment of the present invention.

### DESCRIPTION OF EMBODIMENTS

### [Insulated Wire]

Hereinafter, a preferable embodiment of the insulated wire of the present invention will be described with reference to the drawings. Each drawing is a schematic view for facilitating understanding of the present invention, and the size, the relative magnitude relationship, and the like of each component may be changed for convenience of description, and actual relationships are not illustrated as they are. Furthermore, the present invention is not limited to appearances and shapes illustrated in these drawings, except for the requirements defined by the present invention.

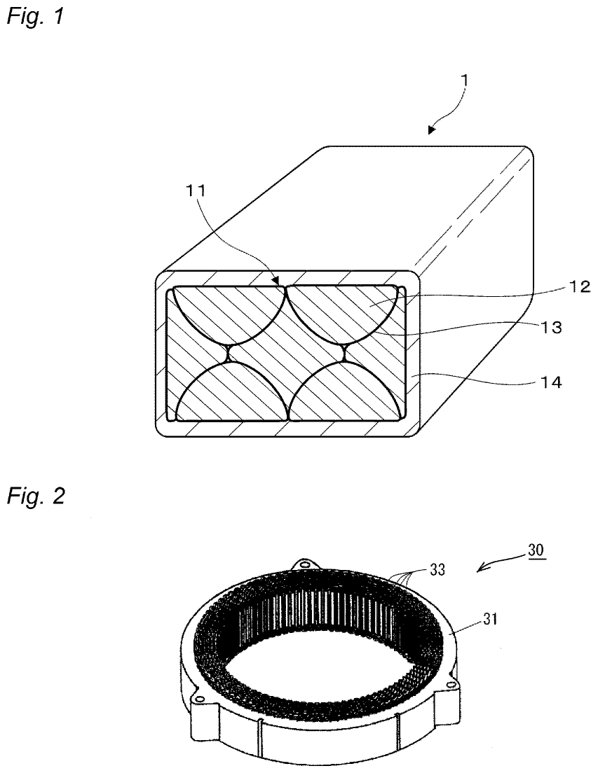

FIG. 1 shows a preferred embodiment of the insulated wire of the present invention. The insulated wire 1 of the present invention has an insulating film 14 on the outer periphery of a split conductor 11. Although not illustrated, the insulated wire 1 may have another layer such as an adhesion layer between the insulating film 14 and the split conductor.

The split conductor 11 is composed of multiple of aluminum strands 12. In the embodiment of FIG. 1, the split conductor 11 is composed of seven strands.

The outer periphery of the strand 12 is insulated and coated with an oxide film 13, whereby eddy current loss is suppressed.

### <Split Conductor>

### —Strand—

In the insulated wire of the present invention, the aluminum strand constituting the split conductor is formed of aluminum alloy containing 0.01 to 0.4 mass % of Fe, 0.3 to 0.5 mass % of Cu, 0.04 to 0.3 mass % of Mg, 0.02 to 0.3 mass % of Si, and 0.001 to 0.01 mass % of Ti and V in total, with the balance being Al and inevitable impurities. This aluminum alloy itself is publicly known, and for example, Japanese Patent No. 5228228 can be referred to.

The content of Fe in the aluminum strand is preferably 0.1 to 0.3 mass %, and more preferably 0.15 to 0.25 mass %.

The content of Cu in the aluminum strand is preferably 0.35 to 0.5 mass %, and more preferably 0.4 to 0.5 mass %.

The content of Mg in the aluminum strand is preferably 0.08 to 0.3 mass %, and more preferably 0.1 to 0.28 mass %.

The content of Si in the aluminum strand is preferably 0.04 to 0.25 mass %, and more preferably 0.04 to 0.20 mass %.

The total content of Ti and V in the aluminum strand is preferably 0.002 to 0.008 mass %, and more preferably 0.003 to 0.006 mass %.

The aluminum strand preferably has a crystal grain size of 5 to 25 μm in a cross section perpendicular to the drawing direction. The crystal grain size is more preferably 5 to 20 μm. The crystal grain size is determined by the method described in paragraph [0050] of Japanese Patent No. 5228118.

The aluminum strand preferably has a tensile strength of 100 MPa or more, more preferably 110 MPa or more, and still more preferably 120 MPa or more. The above tensile strength can be achieved by applying, for example, a production method described later using aluminum strands having the above composition. The tensile strength of the aluminum alloy is usually 160 MPa or less, and is practically 150 MPa, and may be 140 MPa or less, or may be 130 MPa. The tensile strength can be determined by the method described in Examples described later.

The aluminum strand preferably has an electrical conductivity of 58% IACS or more, and also preferably 58 to 62% IACS. The above electrical conductivity can be achieved by applying, for example, a production method to be described later using aluminum strands having the above composition. The electrical conductivity (IACS; International Annealed Copper Standard) can be determined by a method described in Examples described later.

A method for obtaining the aluminum strand used in the present invention includes, for example, the steps of melting an aluminum alloy component containing 0.01 to 0.4 mass % of Fe, 0.3 to 0.5 mass % of Cu, 0.04 to 0.3 mass % of Mg, 0.02 to 0.3 mass % of Si, and 0.001 to 0.01 mass % of Ti and V in total, with the balance being Al and inevitable impurities; then subjecting the melted aluminum alloy component to continuous casting and rolling to form a rough rod; subjecting the rough rod to cold wire drawing to form a rough drawn wire; subjecting the rough drawn wire to heat treatment and wire drawing to form a wire; and further subjecting the wire to annealing heat treatment. The aluminum strand used in the present invention can be obtained by performing the continuous casting and rolling under the condition of a casting cooling rate of 1 to 20° C./sec; performing the cold wire drawing under the condition of a degree of processing represented by η=In (A0/A1) of 1 or more and 6 or less where the wire cross-sectional area before drawing is defined as A0 and the wire cross-sectional area after drawing is defined as A1; performing the heat treatment at 300 to 450° C. for 10 minutes to 6 hours; performing the wire drawing under the condition of a degree of processing of 1 or more and 6 or less; and performing the annealing heat treatment at 300 to 450° C. for 10 minutes to 6 hours.

### —Split Conductor—

In the insulated wire of the present invention, the split conductor is composed of multiple aluminum strands arranged in parallel to each other or multiple aluminum strands twisted into a helix. The number of strands constituting the split conductor is not particularly limited, and is appropriately set according to the purpose. For example, the number can be 2 to 100, or can be 7 to 37.

In the present invention, the expression “arranged in parallel to each other” means including a form of being arranged substantially in parallel to each other. In other words, any form other than the form in which multiple strands are twisted together is a form of “arranged in parallel to each other”. Further, the expression “twisted into a helix” is a form of a so-called stranded wire.

In the split conductor, the oxide film 13 is formed on the outer periphery of each aluminum strand, and functions as an insulating layer. That is, the conduction between strands is prevented by the oxide film 13, so that eddy current loss is suppressed. Therefore, in the present invention, the aluminum strands are not coated with an insulating resin. The oxide film 13 can be formed by natural oxidation when exposed to air. In the aluminum strand 12 used in the present invention, the oxide film 13 is formed sufficiently thick by the natural oxidation. Therefore, the conduction between the strands 12 can be more reliably prevented, so that eddy current loss is effectively suppressed. The thickness of the oxide film 13 is preferably 0.01 to 0.1 μm, and more preferably 0.01 to 0.05 μm.

In the present invention, the formation of the oxide film is not limited to formation by natural oxidation, and the thickness of the oxide film can also be adjusted by wire drawing, heating in a water vapor source, or the like.

FIG. 1 shows the split conductor 11 as a shape having a rectangular cross section (rectangular shape). In the present invention, the split conductor 11 preferably has a rectangular shape. However, the cross-sectional shape of the split conductor is not particularly limited, and can have a desired shape such as a square, a circle, or an ellipse.

The size of the split conductor 11 is not particularly limited. To give an example, when the split conductor 11 has a rectangular shape, the width (long side) thereof is preferably from 1.0 to 5.0 mm, and more preferably from 1.4 to 4.0 mm in rectangular cross section. The thickness (short side) is preferably from 0.4 to 3.0 mm, and more preferably from 0.5 to 2.5 mm. The ratio of length (thickness:width) between the thickness (short side) and the width (long side) is preferably from 1:1 to 1:4. When the split conductor has a circular cross section, the diameter thereof is preferably 0.3 to 3.0 mm, and more preferably 0.4 to 2.7 mm.

### <Insulating Film>

The insulating film 14 is formed on the outer periphery of the split conductor 11. The insulating film 14 may have a single layer or a multilayer structure including two or more insulating layers. The insulating film 14 is preferably, for example, an enamel layer formed by applying varnish and baking. The insulating film 14 can also be formed by extrusion coating.

As a constituent material of the insulating film 14, a material generally used as a constituent material of this type of insulating layer can be widely applied. Examples of the constituent material of the insulating film include a resin material containing at least one type of material selected from polyaryletherketone, polyetherketone, polyetheretherketone, polyphenylene sulfide, polyethylene terephthalate, polyethylene naphthalate, aromatic polyamide, polytetrafluoroethylene, tetrafluoroethylene-hexafluoropropylene copolymer, tetrafluoroethylene-ethylene copolymer, tetrafluoroethylene-perfluoroalkylvinyl ether copolymer, polyetherimide, polyethersulfone, polyphenylene ether, polyphenylsulfone, polyimide, polyamide imide, thermoplastic polyimide, and polyketone. Among them, a resin material containing at least one type of polyimide is preferably used as a constituent material of the insulating film. It is also preferable that the insulating film is formed of a resin material containing polyetheretherketone.

In addition, various additives may be added to the constituent material of the insulating film as long as the effect of the present invention is not impaired. Examples of such additives include a cell nucleating agent, an antioxidant, an antistatic agent, an ultraviolet inhibitor, a light stabilizer, a fluorescent brightening agent, a pigment, a dye, a compatibilizing agent, a lubricating agent, a reinforcing agent, a flame retardant, a crosslinking agent, a crosslinking aid, a plasticizer, a viscosity increaser, a viscosity reducer, and an elastomer.

The insulating film 14 preferably has a 1 to 5 layer structure, and more preferably has 1 to 3 layers. The thickness of the insulating film 14 is preferably 10 to 300 μm, more preferably 20 to 200 μm, further preferably 30 to 200 μm, still further preferably 35 to 200 μm, and particularly preferably 40 to 180 μm.

The insulated wire of the present invention may have an adhesion layer between the insulating film 14 and the split conductor 11. This adhesion layer is a layer for improving the adhesion between the split conductor and the insulating film while improving the accuracy of leveling the unevenness in the outer periphery of the split conductor. The adhesion layer preferably contains polyetherimide.

### [Production of Insulated Wire]

The insulated wire of the present invention can be obtained by an ordinary method except that the aluminum strands defined in the present invention are used as strands constituting a split conductor.

### [Electrical Conducting Wire]

The electrical conducting wire of the present invention can be suitably used as a split conductor constituting the above-described insulated wire of the present invention. Specifically, the electrical conducting wire of the present invention is made of a split conductor composed of multiple aluminum strands arranged in parallel to each other or multiple aluminum strands twisted into a helix. This aluminum strand is composed of aluminum alloy containing 0.01 to 0.4 mass % of Fe, 0.3 to 0.5 mass % of Cu, 0.04 to 0.3 mass % of Mg, 0.02 to 0.3 mass % of Si, and 0.001 to 0.01 mass % of Ti and V in total, the balance being Al and inevitable impurities. Each aluminum strand constituting the electrical conducting wire of the present invention is not coated with an insulating resin.

### [Coil and Electrical or Electronic Equipment]

The insulated wire of the present invention is applicable, as a coil, to a field which requires electrical properties (resistance to voltage) and heat resistance, such as various types of electrical or electronic equipment. For example, the insulated wire of the present invention is used for a motor, a transformer, and the like, by which high-performance electrical or electronic equipment can be obtained. In particular, the insulated wire is preferably used as a winding wire for driving motors of a hybrid vehicle (HV) and an electric vehicle (EV). As descried above, according to the present invention, it is possible to provide electrical or electronic equipment using the insulated wire of the present invention as a coil, such as driving motors of HV and EV.

The coil of the present invention is not particularly limited, as long as it has a form suitable for any of various types of electrical or electronic equipment. Examples thereof include: a coil formed by subjecting the insulated wire of the present invention to coil processing; and a coil formed such that, after the insulated wire of the present invention is bent, predetermined parts thereof are electrically connected.

The coil formed by subjecting the insulated wire of the present invention to coil processing is not particularly limited, and examples thereof include a coil formed by winding a long insulated wire in a spiral. In such a coil, the number of turns of the insulated wire is not particularly limited. Commonly, an iron core or the like is used to wind the insulated wire into a helix.

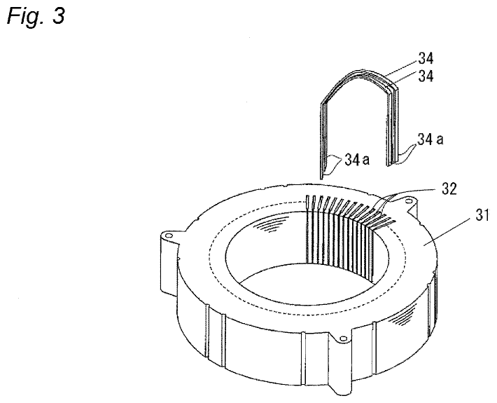

Examples of the coil formed such that, after the insulated wire of the present invention is bent, predetermined parts thereof are electrically connected include a coil used for a stator of a rotating electrical machine, or the like. A coil 33 (see FIG. 2) is an example of such a coil. The coil 33 is formed by cutting the insulated wire of the present invention in a prescribed length, bending the cut pieces in a U shape or the like to form a plurality of wire segments 34, and alternately connecting two open ends (terminals) 34a of the U shape or the like of each wire segment 34, as shown in FIG. 3.

The electrical or electronic equipment using the coil thus produced is not particularly limited. One preferred mode of such electrical or electronic equipment is a transformer. In addition, examples of the preferred mode thereof include a rotating electrical machine (particularly, driving motors of HV and EV) including the stator 30 illustrated in FIG. 2. Such rotating electrical machine can be configured similar to a conventional rotating electrical machine except for being equipped with the stator 30.

The stator 30 has a configuration similar to a configuration of a conventional stator except that the wire segments 34 are produced using the insulated wire of the present invention. Specifically, the stator 30 has a stator core 31, and the coil 33 in which, as shown in FIG. 2, the wire segments 34 produced using the insulated wire of the present invention are incorporated in slots 32 of the stator core 31 and open ends 34a are electrically connected. The coil 33 is fixed such that adjacent fusing layers, or the fusing layer and the slot 32 are bonded. Herein, the wire segment 34 may be placed in each slot 32 one by one. However, it is preferable that a pair of wire segments 34 is placed in each slot 32 as shown in FIG. 3. In the stator 30, the coils 33, which are formed by alternately connecting the open ends 34a that are two ends of the wire segments 34 which have been bent as described above, are housed in the slots 32 of the stator core 31. At this time, the wire segments 34 may be placed in the slots 32 after the open ends 34a thereof are connected. Alternatively, after the wire segments 34 are placed in the slots 32, the open ends 34a of the wire segments 34 may be bent and connected.

The present invention will be described in more detail based on Examples given below. However, it is to be noted that the present invention is not limited to the following Examples.

### EXAMPLES

### [Preparation Example] Production of Aluminum Strand

An aluminum alloy component containing 0.2 mass % of Fe, 0.4 mass % of Cu, 0.2 mass % of Mg, and 0.1 mass % of Si, and 0.005 mass % of Ti and V in total, with the balance being Al and inevitable impurities was melted. Then, the melted aluminum alloy component was subjected to continuous casting and rolling to form a rough rod. The rough rod was subjected to cold wire drawing to form a rough drawn wire. The rough drawn wire was subjected to heat treatment and then to wire drawing to form a wire. The wire was further subjected to annealing heat treatment.

The continuous casting and rolling was performed at a casting cooling rate of 5° C./sec. In addition, the cold wire drawing was performed under the condition that the degree of processing represented by η=In (A0/A1) was 3, where the wire cross-sectional area before drawing was defined as A0 and the wire cross-sectional area after drawing was defined as A1. The heat treatment was performed at 350° C. for 3 hours. The wire drawing was performed under the condition of a degree of processing of 1 or more and 6 or less, and the condition of the annealing heat treatment was set to 400° C. for 2 hours.

In this way, each aluminum strand having a circular cross section with a diameter of 1.24 mm was obtained.

### [Test Example 1] Tensile Strength

The obtained three aluminum strands were subjected to a tensile test in accordance with JIS Z 2241: 2011 to determine the average value of the tensile strengths (MPa) of the three aluminum strands.

### [Test Example 2] Electrical Conductivity

The electrical conductivities of the obtained three aluminum strands were measured, and the average value thereof was determined. The electrical conductivity was calculated from the numerical value of the specific resistance measured by a four-terminal method in a thermostat bath maintained at 20° C. (±0.5° C.). The distance between the terminals was 100 mm.

### [Test Example 3] Thickness of Oxide Film

The thickness of the oxide film formed on the surface of the obtained aluminum strand by natural oxidation was examined by Auger spectroscopy.

The results of the above test examples are shown in the following table. The aluminum strands of the comparative products in the table below were formed into a shape having a circular cross section with a diameter of 1.24 mm by a wire drawing process.

TABLE 1

| | | Tensile | Electrical | Thickness |
|---|---|---|---|---|
| | | strength | conductivity | of oxide |
| | | (MPa) | (IACS%) | film (μm) |
| Preparation Example (strand | | 122 | 60 | 0.025 |
| defined in the present invention) | | | | |
| Comparative | A1050 (pure | 77 | 61 | 0.005 |
| product | aluminum) | | | |
| | A1070 (pure | 69 | 62 | 0.003 |
| | aluminum) | | | |
| | A1100 (aluminum) | 90 | 59 | 0.006 |
| | A6061 (aluminum) | 125 | 47 | 0.008 |

From the results of evaluation of properties of the strands shown in the above table, it can be seen that the electrical conducting wire of the present invention has an electrical conductivity equivalent to that of pure aluminum, and the mechanical strength thereof is remarkably stronger than that of pure aluminum. Furthermore, it can be seen that the electrical conducting wire of the present invention can sufficiently thicken the oxide film, so that eddy current loss can be more reliably prevented.

Having described our invention as related to the present embodiments, it is our intention that the invention not be limited by any of the details of the description, unless otherwise specified, but rather be construed broadly within its spirit and scope as set out in the accompanying claims.

### DESCRIPTION OF SYMBOLS

1 Insulated wire
11 Split conductor
12 Aluminum strand
13 Oxide film
14 Insulating film
30 Stator
31 Stator core
32 Slot
33 Coil
34 Wire segment
34a Open end

1. An electrical conducting wire, comprising:
a split conductor composed of multiple aluminum strands arranged in parallel to each other or multiple aluminum strands twisted into a helix,
wherein each of the strands contains 0.01 to 0.4 mass % of Fe, 0.3 to 0.5 mass % of Cu, 0.04 to 0.3 mass % of Mg, 0.02 to 0.3 mass % of Si, and 0.001 to 0.01 mass % of Ti and V in total, with the balance being Al and inevitable impurities; and
wherein each of the strands is not coated with an insulating resin.

2. The electrical conducting wire according to claim 1, wherein a tensile strength of each of the strands is 100 MPa or more.

3. The electrical conducting wire according to claim 1, wherein an electrical conductivity of each of the strands is 58% IACS or more.

4. An insulated wire, comprising: the electrical conducting wire according to claim 1; and an insulating film coating an outer periphery of the electrical conducting wire.

5. The insulated wire according to claim 4, wherein the insulating film is an enamel layer.

6. The insulated wire according to claim 4, wherein the insulating film contains polyimide.

7. The insulated wire according to claim 4, wherein the insulating film contains polyetheretherketone.

8. The insulated wire according to claim 4, comprising an adhesion layer between the insulating film and the electrical conducting wire, wherein the adhesion layer contains polyetherimide.

9. A coil, comprising the insulated wire according to claim 4.

10. An electrical or electronic equipment, comprising the coil according to claim 9.
